(19) United States
(12) Patent Application Publication
(10) Pub. No.: US 2011/0279525 A1
(43) Pub. Date: Nov. 17, 2011

(54) RECORDING APPARATUS

(75) Inventors: Seiji Suzuki, Ebina-shi (JP); Yuji Kanome, Yokohama-shi (JP); Hiroyuki Tanaka, Kawasaki-shi (JP); Yoshiaki Suzuki, Nagareyama-shi (JP); Masahiro Sugimoto, Yokohama-shi (JP); Susumu Hirosawa, Tokyo (JP); Takeaki Nakano, Inagi-shi (JP)

(73) Assignee: CANON KABUSHIKI KAISHA, Tokyo (JP)

(21) Appl. No.: 12/963,230

(22) Filed: Dec. 8, 2010

(30) Foreign Application Priority Data
May 17, 2010 (JP) 2010-113434

(51) Int. Cl. B41J 2/165

(52) U.S. Cl. 347/30

(57) ABSTRACT

An apparatus includes a recording head having nozzle chips arranged in a staggered configuration along a second direction that intersects a first direction in which a sheet is conveyed, a first suction portion corresponding to a first row of nozzle chips in the staggered configuration, and a second suction portion corresponding to a second row of nozzle chips. The first suction portion and the second suction port are in a positional relationship in which they are displaced in the second direction so as to correspond to displacement between a first nozzle chip in the first row and its neighboring second nozzle chip in the second row in the second direction. The apparatus further includes a positioning member having a plurality of reference surfaces for use in positioning the recording head at different locations in a third direction that intersects the first direction and the second direction.

### BACKGROUND OF THE INVENTION

1. Field of the Invention

The present invention relates to an inkjet recording apparatus using a line-type recording head.

2. Description of the Related Art

For an inkjet recording apparatus, dry ink in a nozzle of a head may become thickened and stick to the nozzle. Also, poor ink ejection resulting from clogging caused by intrusion of paper lint, dust, or bubbles into ink in a nozzle may degrade recording quality. To address these conditions, the recording head needs cleaning.

Japanese Patent Laid-Open No. 5-201028 discloses a cleaning mechanism that aims at recovery by forcibly sucking ink from a recording head. This cleaning mechanism includes a suction port shorter than the full length of a row of nozzles of the recording head and performs suction on all of the nozzles while moving the suction port along a direction in which the row of nozzles is disposed.

There is a line-type recording head having a plurality of nozzle chips regularly arranged in a staggered configuration. Typically, a specific gap is present between neighboring nozzle chips in each row of the staggered configuration. In some cases, that gap has a height different from the surface of each nozzle.

### SUMMARY OF THE INVENTION

The present invention provides a recording apparatus capable of reliably cleaning a nozzle surface of a line-type recording head in which a plurality of nozzle chips is regularly arranged. The present invention also provides a recording apparatus capable of properly positioning a recording head in various operation modes in which the recording apparatus is operative, such as suction mode and wiping mode, using a simple positioning structure and capable of implementing each operation mode more reliably.

According to an aspect of the present invention, an apparatus includes a recording head, a first suction portion, a second suction portion, a suction holder, a movement mechanism, and a positioning member. The recording head is disposed at a location that faces a sheet moving in a first direction. The recording head includes a plurality of first nozzle chips and a plurality of second nozzle chips arranged in different rows along a second direction that intersects the first direction. Each of the plurality of first nozzle chips and each of the plurality of second nozzle chips include a nozzle array. The first nozzle chips and the second nozzle chips adjacent to each other are displaced from each other in the second direction. The first suction portion is configured to face the first nozzle chip and suck ink from part of the nozzle array included in the first nozzle chip. The second suction portion is configured to face the second nozzle chip and suck ink from part of the nozzle array included in the second nozzle chip. The suction holder is configured to hold the first suction portion and the second suction portion. The movement mechanism is configured to cause relative movement between the recording head and the suction holder along the second direction while suction is performed. The positioning member is for use in positioning the recording head at a plurality of locations in a third direction that intersects the first and second directions. The first suction portion and the second suction portion are in a positional relationship in which they are displaced in the second direction so as to correspond to displacement between the first nozzle chip and the second nozzle chip.

With the present invention, a recording apparatus capable of reliably cleaning a nozzle surface of a line-type recording head in which a plurality of nozzle chips is regularly arranged can be achieved. The recording apparatus can reliably implement various operation modes in which it is operative.

Further features of the present invention will become apparent from the following description of exemplary embodiments with reference to the attached drawings.

### BRIEF DESCRIPTION OF THE DRAWINGS

FIG. 1 is a perspective view of a main section of a recording apparatus according to an embodiment of the present invention.

FIG. 2 is a cross-sectional view of the main section of the recording apparatus.

FIG. 3 is a perspective view that illustrates a cleaning operation state.

FIGS. 4A and 4B illustrate a structure of a recording head.

FIGS. 5A and 5B illustrate a structure of a nozzle chip.

FIG. 6 is a partially enlarged view that illustrates a positional relationship between nozzle chips and suction ports.

FIG. 7 is a perspective view that illustrates a state of a cleaning mechanism.

FIG. 8 is a perspective view that illustrates another state of the cleaning mechanism.

FIG. 9 illustrates a configuration of a wiper unit.

FIGS. 10A to 10C are perspective views that illustrate an operation of switching the position of blades.

FIGS. 11A and 11B are perspective views that illustrate an operation of switching the position of the blades.

FIGS. 12A and 12B are side views that illustrate how the cleaning mechanism is operated.

FIG. 13 illustrates another example array of nozzle chips.

FIG. 14 is a flowchart of a cleaning operation sequence.

FIG. 15 illustrates a configuration of an example in which an absorber is employed as a suction portion.

FIGS. 16A and 16B are enlarged views of a reference member and its adjacent areas.

FIGS. 17A to 17C illustrate positional relationships between the reference member and a positioning member.

### DESCRIPTION OF THE EMBODIMENTS

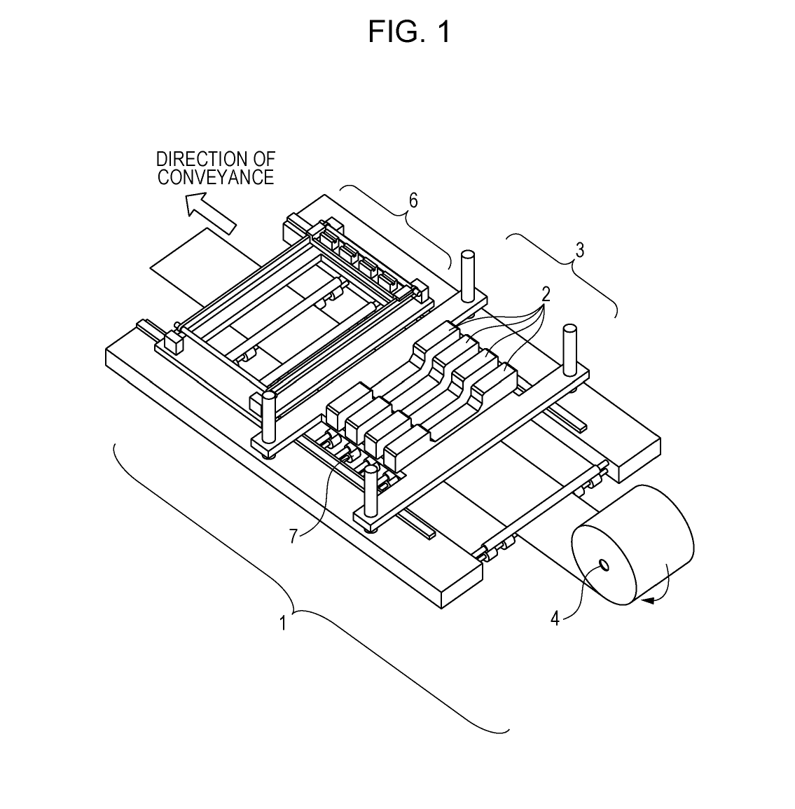

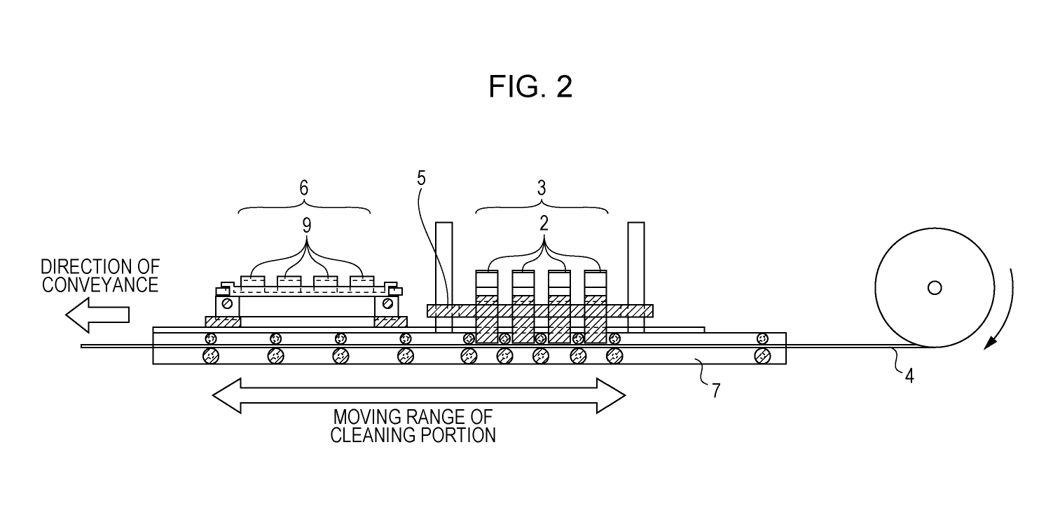

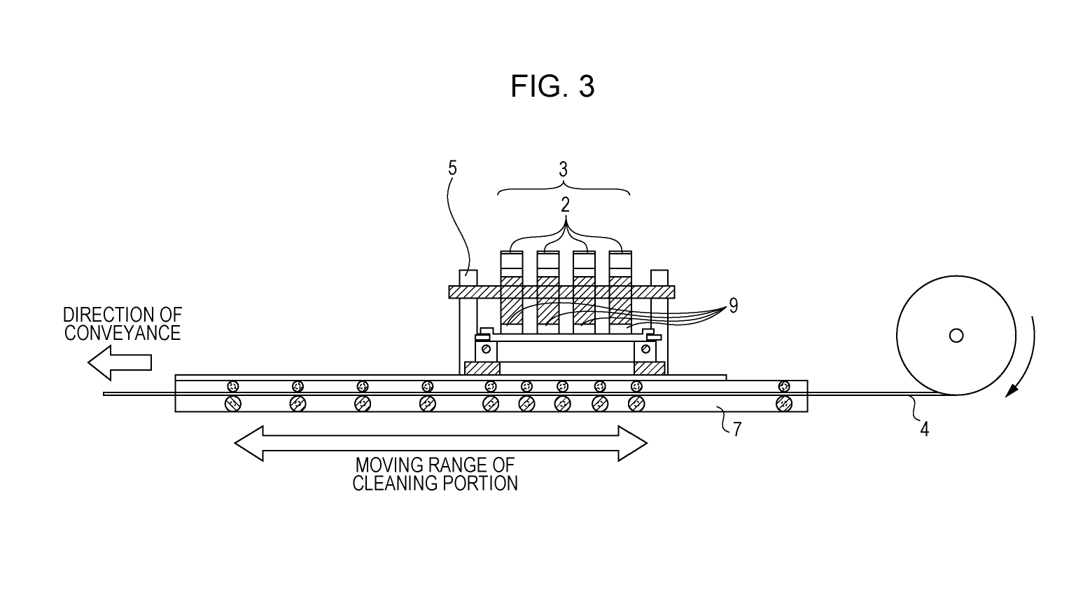

Embodiments of the present invention are specifically described with reference to the drawings. FIG. 1 is a perspective view that illustrates a configuration of a main section substantially centered on a recording portion of a recording apparatus according to an embodiment of the present invention. FIG. 2 illustrates a cross-sectional structure of the main section in FIG. 1. FIG. 3 is a cross-sectional view that illustrates a cleaning operation state.

A recording apparatus 1 according to the present embodiment is a line printer that prints information while continuously conveying a sheet in a direction of conveyance (first direction) using a long line head. The recording apparatus 1 includes a holder that holds a sheet 4 (e.g., a continuous roll of paper), a conveyance mechanism 7 configured to convey the sheet 4 in the first direction at a specific speed, and a recording portion 3 configured to record information on the sheet 4 using a line head. The sheet 4 is not limited to a continuous roll of paper; it may be a cut sheet. The recording apparatus 1 further includes a cleaning portion 6 configured to clean a nozzle surface of a recording head by wiping. The recording apparatus 1 also includes a cutter unit configured to cut the sheet 4, a drying unit configured to forcibly dry the sheet 4, and a discharge tray, which are disposed downstream of the recording portion 3 along a sheet conveying path.

The recording portion 3 includes a plurality of recording heads 2 individually corresponding to different ink colors. For the present embodiment, four recording heads corresponding to four colors of cyan, magenta, yellow, and black (CMYK) are used. However, the number of colors is not limited to four. Each color ink is supplied to a corresponding recording head 2 from a corresponding ink tank through a corresponding ink tube. The plurality of recording heads 2 are integrally held by a head holder 5. The recording portion 3 also includes a mechanism that enables the head holder 5 to move upward and downward to change the distance between the surface of the sheet 4 and each of the recording heads 2. The recording portion 3 further includes a mechanism that enables translational motion of the head holder 5 in a direction (second direction) that intersects the first direction.

The cleaning portion 6 includes a plurality of (four) cleaning mechanisms 9 corresponding to the plurality of (four) recording heads 2. The details of the cleaning mechanisms 9 are described below. The cleaning portion 6 is slidable in the first direction by a drive motor. FIGS. 1 and 2 illustrate a state during recording. In this state, the cleaning portion 6 is positioned downstream of the recording portion 3 in the direction of conveyance of a sheet. FIG. 3 illustrates a state during a cleaning operation. In this state, the cleaning portion 6 is positioned immediately below the recording head 2 of the recording portion 3. In FIGS. 2 and 3, the moving range of the cleaning portion 6 is indicated by the arrows.

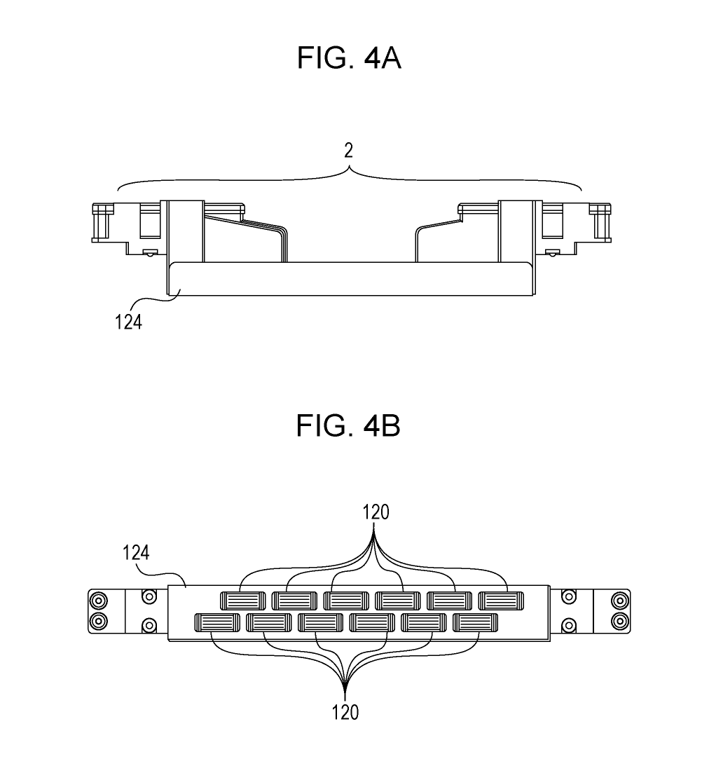

FIGS. 4A and 4B illustrate a structure of one of the recording heads 2. Inkjet printing can use a system that employs a heater element, a system that employs a piezoelectric element, a system that employs an electrostatic element, and a system that employs a micro-electrical-mechanical system (MEMS). The recording head 2 is a line-type recording head in which an inkjet nozzle array is disposed in a range that covers the maximum width of a sheet estimated to be used. The direction in which the nozzle arrays are arranged is a direction (second direction) that intersects (e.g., substantially perpendicular to) the first direction. A plurality of nozzle chips 120 are arranged along the second direction on a large base substrate 124. As illustrated in FIG. 4B, the plurality of (in the present embodiment, 12) nozzle chips 120 having substantially the same dimensions and substantially the same structure are regularly arranged in two rows in a staggered configuration over the full range in the width direction. That is, the recording head 2 includes a plurality of first nozzle chips each having nozzle arrays and a plurality of second nozzle chips each having nozzle arrays arranged in different rows along the second direction and is in a positional relationship in which the first nozzle chips and the second nozzle chips adjacent to each other are displaced from each other in the second direction. For the neighboring first and second nozzle chips, part of the nozzle arrays included in the first nozzle chip and that in the second nozzle chip overlap each other in the second direction.

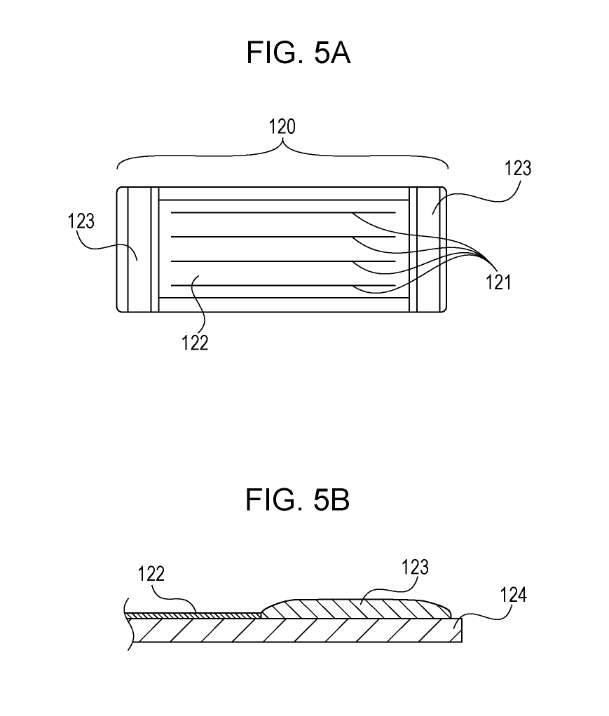

FIGS. 5A and 5B illustrate a structure of one of the nozzle chips 120 forming the recording head 2. The nozzle chip 120 includes a nozzle surface 122 in which a plurality of nozzle arrays 121 for use in ejecting ink is disposed and a nozzle substrate in which energy elements corresponding to their respective nozzles are embedded. The plurality of (in the present embodiment, four) nozzle arrays 121 are arranged in four rows substantially in parallel along the first direction. The nozzle substrate of the nozzle chip 120 is disposed on the base substrate 124. The nozzle substrate and the base substrate 124 are connected by an electric connection portion disposed therebetween. The electric connection portion is covered with a sealing portion 123 made of resin so that it is protected from corrosion or breakage. As illustrated in FIG. 5B, when the nozzle surface 122 is viewed from one side, the sealing portion 123 is disposed on the base substrate 124 and is a projection whose top is higher than the nozzle surface 122 in an ink ejection direction (a direction that intersects the first direction and the second direction: third direction). For one nozzle chip 120, the sealing portion 123 lies in the vicinity of each of both two ends of the nozzle surface 122 in a direction in which the nozzle arrays are arranged (second direction). In this way, the sealing portion 123 is adjacent to the plurality of nozzle arrays 121 and has a shape that gradually increases its height so as to project at least partly beyond the nozzle surface 122 in the ink ejection direction.

As illustrated in FIGS. 5A and 5B, the recording head may include the sealing portion 123, which is a projection whose top is higher than the nozzle surface 122, to protect an electrode. If such a recording head is subjected to suction by the suction mechanism described in the above-mentioned patent document, issues described below arise.

In the course of movement of a suction port along a nozzle array, the suction port moves upward when rises up onto and over the sealing portion 123, which has a height different from the other regions. In a direction in which the suction port moves, the location of the sealing portion 123 on a nozzle-chip row corresponds to a nozzle array 121 in its neighboring nozzle-chip row. When part of the suction port rises up onto the sealing portion 123 of a nozzle-chip row, the whole suction port also moves upward, and this may break intimate contact between the suction port and a nozzle of its neighboring nozzle-chip row and may result in poor suction.

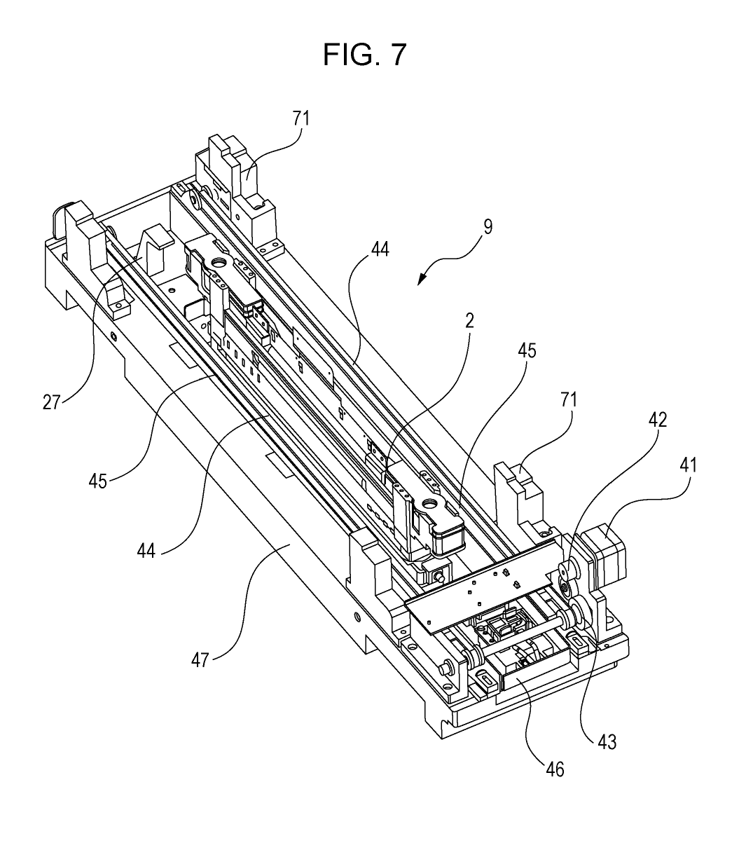

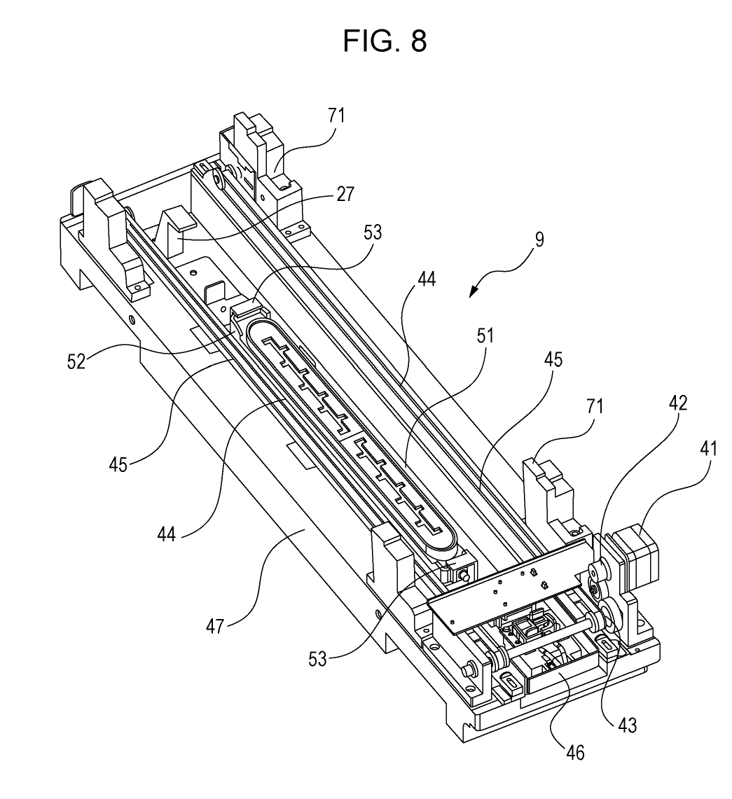

FIGS. 7 and 8 are perspective views that illustrate a detailed configuration of one cleaning mechanism 9 included in the cleaning portion 6. FIG. 7 illustrates the cleaning mechanism 9 in a state in which the cleaning portion 6 is positioned directly below the recording head 2 (during a cleaning operation), as illustrated in FIG. 3. FIG. 8 illustrates the cleaning mechanism 9 in a state in which the cleaning portion 6 is not positioned directly below the recording head 2, as illustrated in FIG. 2. The single cleaning mechanism 9 includes a single cap 51 and four reference members 71.

The cleaning mechanism 9 includes a wiper unit 46 configured to wipe ink and dirt off the nozzle surface of the recording head 2, a movement mechanism configured to move the wiper unit 46 along a direction of wiping (second direction), and a frame 47 supporting them integrally. The wiper unit 46 includes integrally movable wiper blades and suction ports, which are described below. The movement mechanism moves the wiper unit 46 guided and supported by two shafts 45 in the second direction by driving of a driving source. The driving source includes a driving motor 41 and reduction gears 42 and 43 and rotates a driving shaft. The rotation of the driving shaft is transmitted through a belt 44 and a pulley and moves the wiper unit 46. The wiper unit 46 functions to remove ink and dirt from the nozzle surface of the recording head 2 by the use of a combination of the blades and the suction ports, as described below. A trigger lever 27 for switching the orientation of blades 21, which are described below, is disposed on the frame 47 outside the wiping range.

Referring to FIG. 8, the cap 51 is held by a cap holder 52. The cap holder 52 is urged by a spring being an elastic body in a direction substantially perpendicular to the nozzle surface of the recording head 2 and is movable against the spring. In a state where the frame 47 is in a cap position, when the recording head 2 is moved in a direction substantially perpendicular to the nozzle surface, intimate contact with the cap 51 and separation therefrom are carried out. The nozzle surface is capped by intimate contact, thus reducing drying out of nozzles.

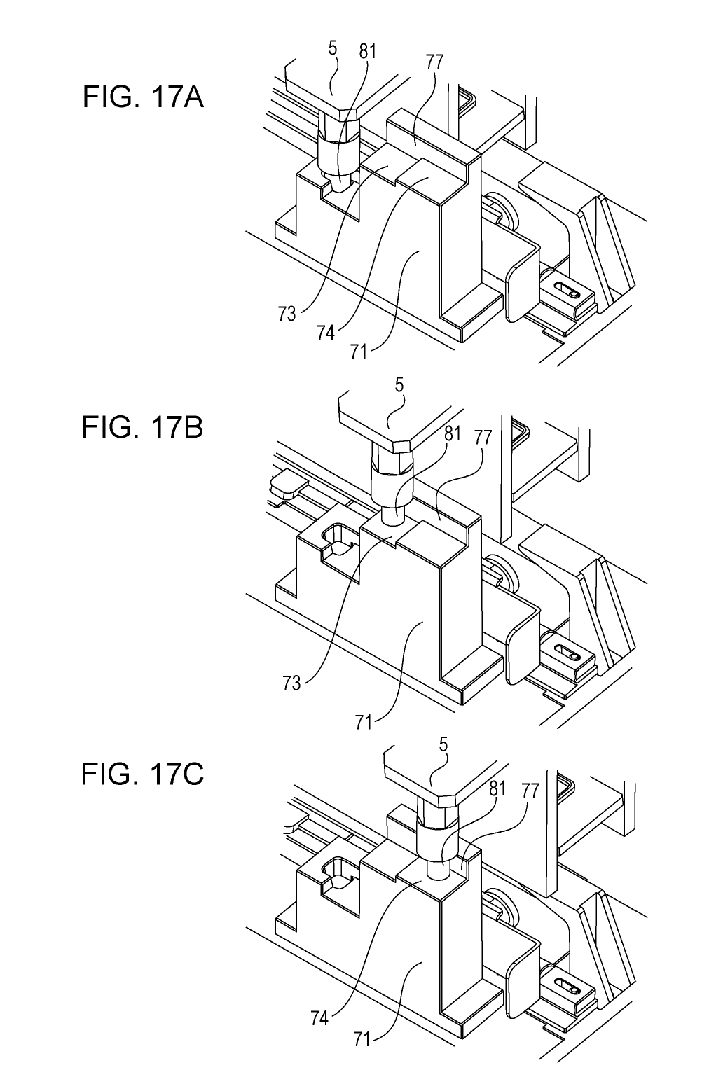

The four reference members 71 are provided to the cleaning mechanism 9 in order to establish a positional relationship between the recording head 2 and the cleaning portion 6. Positioning is achieved by the four reference members 71 coming into contact with four positioning members (see FIGS. 17A to 17C) fixed on the lower surface of the head holder 5. In capping mode, cleaning mode, and wiping mode, positioning is achieved at different heights (in a direction substantially perpendicular to the nozzle surface: third direction). Positioning is also achieved in the first direction and the second direction.

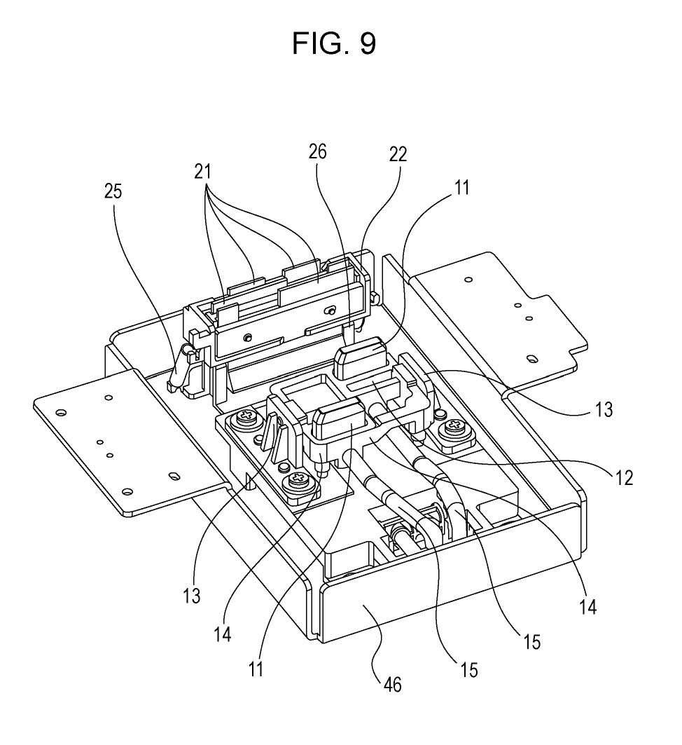

FIG. 9 illustrates a configuration of the wiper unit 46. The wiper unit 46 includes two suction ports 11 (first and second suction portions) corresponding to the first and second nozzle-chip rows. The gap in the first direction between the two suction ports 11 is substantially the same as the gap between the two nozzle-chip rows. The two suction ports 11 are displaced in the second direction by an amount substantially the same as the amount of displacement (specific distance) between neighboring nozzle chips in two nozzle-chip rows. The suction ports 11 are held by a suction holder 12. The suction holder 12 is urged by a spring 14 being an elastic body in a direction substantially perpendicular to the nozzle surface of the recording head 2 (third direction) and is movable in the third direction against the spring. That is, the suction holder 12 is supported by a displacement mechanism having an elastic body so as to be able to be displaced rectilinearly in a direction of the gap between the nozzle surface and a sheet (third direction). The displacement mechanism serves to absorb movement occurring when each of the moving suction ports 11 rises up onto and over the sealing portion 123. The details are described below.

Each of the two suction ports 11 is connected to a tube 15 through the suction holder 12. The tube 15 is connected to a negative-pressure producing unit, such as a suction pump. When the negative-pressure producing unit is activated, a negative pressure for use in sucking ink and dirt is supplied to the inside of the suction port 11. The four blades 21, which are made up of two right blades and two left blades, are held by a blade holder 22. Both ends of the blade holder 22 in the first direction are supported, thus allowing the blade holder 22 to be rotatable about the first direction as a rotation shaft. The blade holder 22 is urged by a spring 25 against a stopper 26 under normal conditions. The orientation of the blade surface of each of the blades 21 is switchable between a wiping position and a withdrawal position by a switching mechanism described below. The suction holder 12 and the blade holder 22 are disposed on a common support of the wiper unit 46.

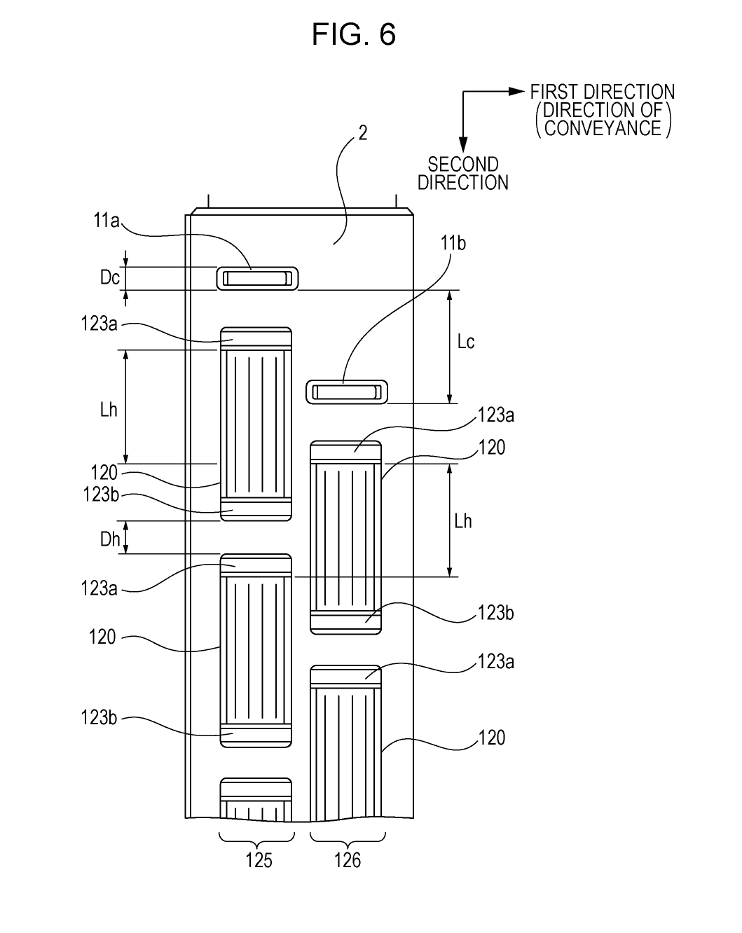

FIG. 6 is a partially enlarged view that illustrates a positional relationship between the nozzle chips 120 of the recording head and the suction ports 11. In a staggered configuration having two rows, a nozzle chip 120 in a row and its neighboring nozzle chip 120 in its neighboring row are spaced away from each other in the second direction by a specific distance Lh. The two suction ports 11 are made up of a first suction port 11a corresponding to a first nozzle-chip row 125 and a second suction port 11b corresponding to a second nozzle-chip row 126. The first suction port 11a and the second suction port 11b are spaced away from each other in the first direction by a distance substantially the same as the distance between the first nozzle-chip row 125 and the second nozzle-chip row 126 (center-to-center distance). Each of the first suction port 11a and the second suction port 11b is arranged such that its opening is positioned in a range that covers a plurality of nozzle arrays included in the corresponding nozzle chip 120 in the first direction. The first suction port 11a and the second suction port 11b are arranged so as to be displaced in the second direction by a distance Lc. In the second direction, the distance Lh of displacement of the nozzle chips 120 is equal to the distance Lc of displacement of the suction ports. “Being equal” used here is not limited to being strictly equal; it also includes being virtually equal. The same applies to the expression “being equal” used in the present invention. Being virtually equal used here indicates, for example, an extent to which the first suction port 11a and the second suction port 11b can come into contact with a sealing portion 123a and a sealing portion 123b, respectively, at substantially the same time. In other words, the distance Lh of displacement and the distance Lc of displacement are equal to an extent to which the two suction ports can come into contact with the corresponding sealing portions of the nozzle chips at substantially the same time. In this manner, the first suction portion and the second suction portion are in a positional relationship in which they are displaced in the second direction so as to correspond to displacement between neighboring first and second nozzle chips in different rows.

Each of the first suction port 11a and the second suction port 11b has a width Dc in the second direction. The width Dc indicates a range that covers part of the nozzle array in the second direction and corresponds to a few nozzles to several tens of nozzles. In the recording head 2, for each row along the second direction, the gap between the neighboring nozzle chips 120 in the same row (gap between ends of the sealing portions) is a distance Dh. The width Dc and the distance Dh satisfy the relationship Dc<Dh. The satisfaction of such a positional relationship can narrow the gap between the neighboring suction ports 11, inhibit extension of the gap between the nozzle chips in the first direction, and suppress an increase in size of the apparatus.

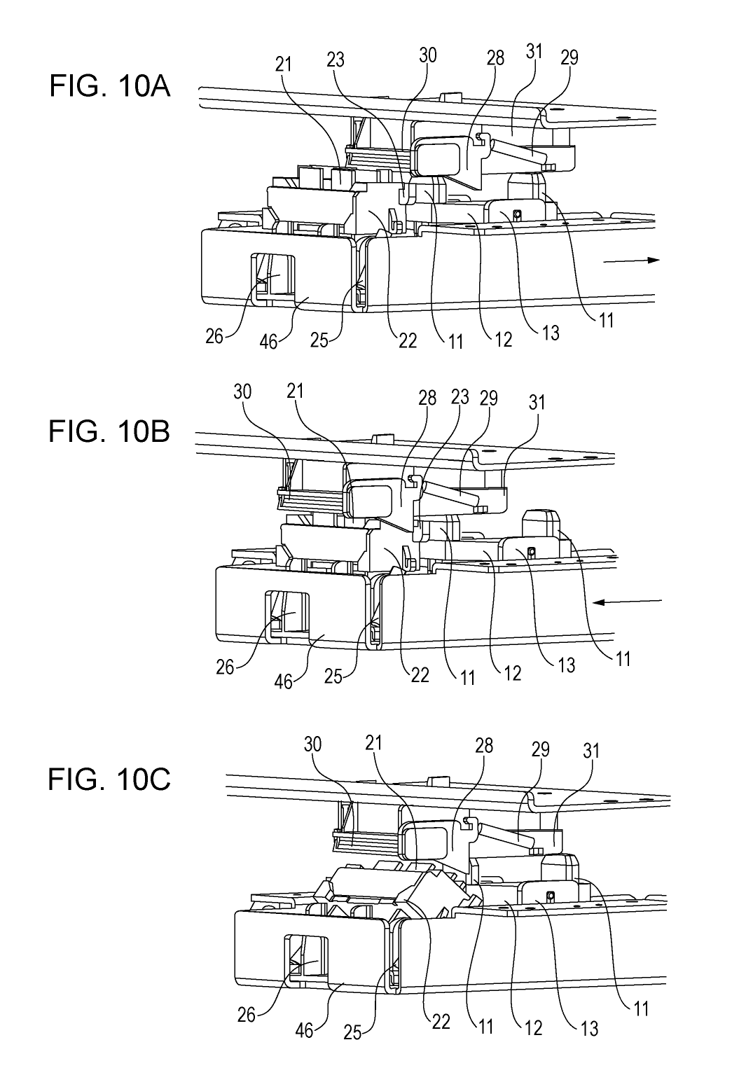

Next, an operation of switching the blades 21 from a wiping position to a withdrawal position is described using FIGS. 10A to 10C. Referring to FIGS. 10A to 10C, outside the wiping range, a cleaner holder 31 is disposed at a location facing the wiper unit 46. The cleaner holder 31 holds a blade cleaner 30 for scraping ink from the blades 21 in wiping the recording head 2. The cleaner holder 31 pivotally supports a release lever 28 being urged by tension of a spring 29. The release lever 28 is disposed at a location where it can come into contact with a contact portion 23.

FIG. 10A illustrates a state of the blades 21 during wiping the nozzle surface. The orientation of the blade holder 22 is normal, and the blade surface of each of the blades 21 is in an orientation substantially perpendicular to the nozzle surface of the recording head 2 (wiping position). In this state, the tips of the blades 21 are nearer to the nozzle surface of the recording head 2 than the tips of the suction ports 11 are. When the wiper unit 46 moves in the direction of the arrow illustrated in FIG. 10A, the blades 21 come into contact with the blade cleaner 30, and ink and dirt is scraped from the blades 21 by the blade cleaner 30. In course of this operation, the contact portion 23 of the wiper unit 46 comes into contact with an inclined surface of the release lever 28. The inclined surface of the release lever 28 is pressed by the contact portion 23 and gradually pivoted against the urging of the spring 29. When the contact portion 23 exceeds the inclined surface of the release lever 28, the release lever 28 is returned to the original state by the urging of the spring 29.

FIG. 10B illustrates a state in which cleaning of the blades 21 has been completed. When the wiper unit 46 moves in the direction of the arrow illustrated in FIG. 10B, the contact portion 23 comes into contact with an end face of the release lever 28. Even if the release lever 28 is pushed from this direction, the release lever 28 does not pivot because it is fixed by a securing portion of the cleaner holder 31. Therefore, the contact portion 23 is pressed by the release lever 28, and the blade holder 22 is pivoted in a direction opposite to the direction of travel of the wiper unit 46 against urging by tension of the spring 25. When the pivoting has been completed, the tension of the spring 25 acts as a force in a direction in which the pivoted state is kept.

FIG. 10C illustrates a state occurring as a result of the pivoting of the blade holder 22. The blade holder 22 is oriented obliquely, and the blade surface of each of the blades 21 is in an orientation tilted with respect to the nozzle surface of the recording head 2 (withdrawal position). In this state, the tip of the blade 21 is more remote from the nozzle surface, in comparison with that in the previously described wiping position, and is not in contact with the nozzle surface. That is, the positional relationship in this state is that, in the third direction, the tip of the suction port 11 (the site nearest the nozzle surface of the suction portion) is present between the location of the tip of the blade in the wiping position and the location of the tip of the blade in the withdrawal position.

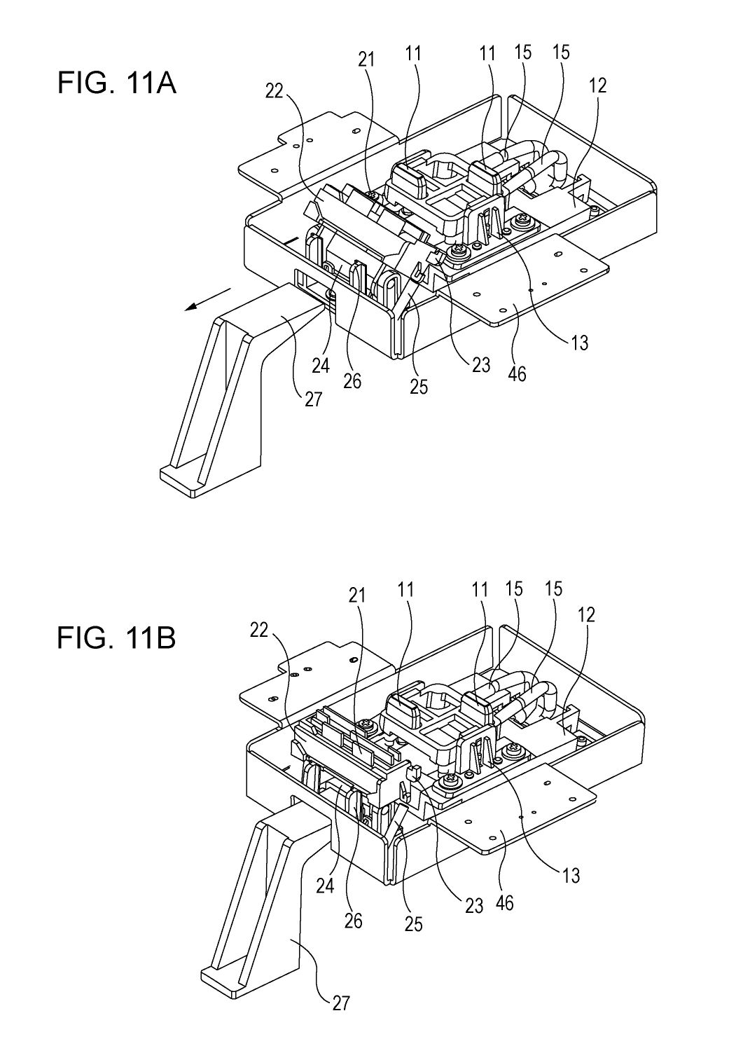

An operation of switching the blades 21 from a withdrawal position to a wiping position is described below using FIGS. 11A and 11B. In a state where the blades 21 are in the withdrawal position illustrated in FIG. 11A, the wiper unit 46 moves in the direction of the arrow. The contact portion 23 of the blade holder 22 comes into contact with the tip of the trigger lever 27 fixed to the frame 47. When it further moves, the blade holder 22 is pressed by the trigger lever 27 and pivoted, and the blades 21 moves to the wiping position illustrated in FIG. 11B and switching is completed.

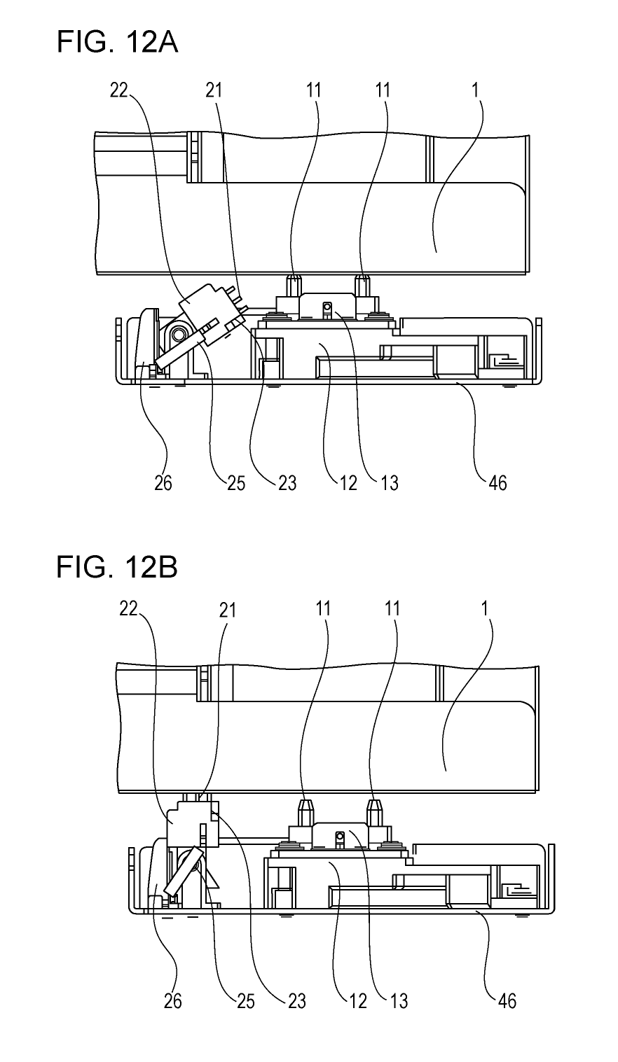

FIGS. 12A and 12B are side views for use in describing an operation of the cleaning mechanism. FIG. 12A illustrates a suction-mode state at which the recording head 2 is cleaned by the suction ports 11. FIG. 12B illustrates a wiping-mode state at which the recording head 2 is cleaned by the blades 21.

In suction mode, as illustrated in FIG. 12A, the blades 21 are in the withdrawal position. The position of the recording head 2 in the third direction (suction-mode position) is set such that the tip of each of the suction ports 11 and the nozzle surface of the recording head 2 are in contact with each other, and the set position is kept. When the wiper unit 46 is moved in the second direction while the negative-pressure producing unit produces a negative pressure in the suction port 11, ink and dirt on the nozzles can be sucked and removed through the suction port 11. In course of moving the wiper unit 46 in the second direction, the suction port 11 is pressed in the third direction by the sealing portion 123 projecting beyond the nozzle surface. As previously described, the suction holder 12 in the wiper unit 46 can be displaced in a direction in which it escapes from the nozzle surface (third direction). Therefore, even when the suction port 11 is pressed, the movement can be relieved by the displacement of the suction holder 12. Making the suction port 11 and the nozzle surface come into contact with each other in cleaning by suction is not necessarily required. For example, suction can be achieved by providing a negative pressure when they are close to each other without causing them to come into contact. That is, in suction mode, it is necessary to cause the suction port 11 and the nozzle surface to be adjacent to each other (they may be in contact).

As illustrated in FIG. 6, which is previously described, because the distances Lh and Lc are substantially the same, the first suction port 11a and the second suction port 11b confront the respective sealing portions 123 of the nozzle chips 120 at substantially the same time. After that, the first suction port 11a and the second suction port 11b also confront the nozzle arrays included in the first and second nozzle chips 120, respectively, at substantially the same time. When each of the suction ports 11 rises up onto the step to the sealing portion 123, a force for tilting the suction port 11 is provided to the suction holder 12 thorough the suction port 11 and the suction holder 12 is tilted. When the suction port 11 is onto the sealing portion 123, the suction port 11 is pressed and displaced in the third direction. Because the first suction port 11a and the second suction port 11b rise up onto the sealing portions 123 in the corresponding rows at substantially the same time, the two suction ports tilt the suction holder 12 at virtually the same time. The first suction port 11a and the second suction port 11b are also pressed in the third direction at substantially the same time. Therefore, during suction performed on nozzles using the first suction port 11a and the second suction port 11b, unstable suction resulting from undesired tilting or pushing of the suction holder 12 does not occur. From the above reason, reliability in cleaning of nozzles is improved.

In suction mode, the wiper unit 46 is caused by the movement mechanism to reciprocate in the second direction. The negative-pressure producing unit is controlled such that a negative pressure, that is, a suction force, provided to the inside of the suction port 11 for forward movement and that for backward movement are different. Specifically, the negative pressure for forward movement is larger than that for backward movement. In suction mode, the wiper unit 46 reciprocates in the second direction at different moving speeds for forward movement and backward movement. Specifically, the speed for forward movement is smaller than that for backward movement. For suction through forward and backward movement, typically, most of ink and dirt are sucked in the initial forward movement, and slightly remaining ink and dirt are removed in the next backward movement. Accordingly, for forward movement, in which a larger amount of ink is typically sucked, a negative pressure is set larger, and a moving speed is set lower and the wiper unit 46 is moved slower than for backward movement. With this, the initial operation can reliably suck a large quantity of ink and dirt. For backward movement, a negative pressure is set smaller and a speed is set higher. With this, power consumption and sound during operation can be reduced, and the total time required for reciprocation can be shortened.

In wiping mode, as illustrated in FIG. 12B, the blades 21 are switched to the wiping position. The position of the recording head 2 in the third direction (wiping-mode position) is set such that the tip of each of the blades 21 and the nozzle surface of the recording head 2 are in contact with each other, and the set position is kept. At this time, the tip of the suction port 11 is more remote from the nozzle surface of the recording head 2 than in the state illustrated in FIG. 12A. The negative-pressure producing unit is deactivated. When the wiper unit 46 is moved along the second direction in a scanning manner, the blades 21 can wipe ink and dirt off the nozzle surface and remove them.

As described above, the cleaning mechanism is operative in two mode of suction mode and wiping mode, and the same wiper unit 46 can selectively implement either mode. For example, an ink ejection state of nozzles is determined, and in response to the determination, appropriate mode is selected.

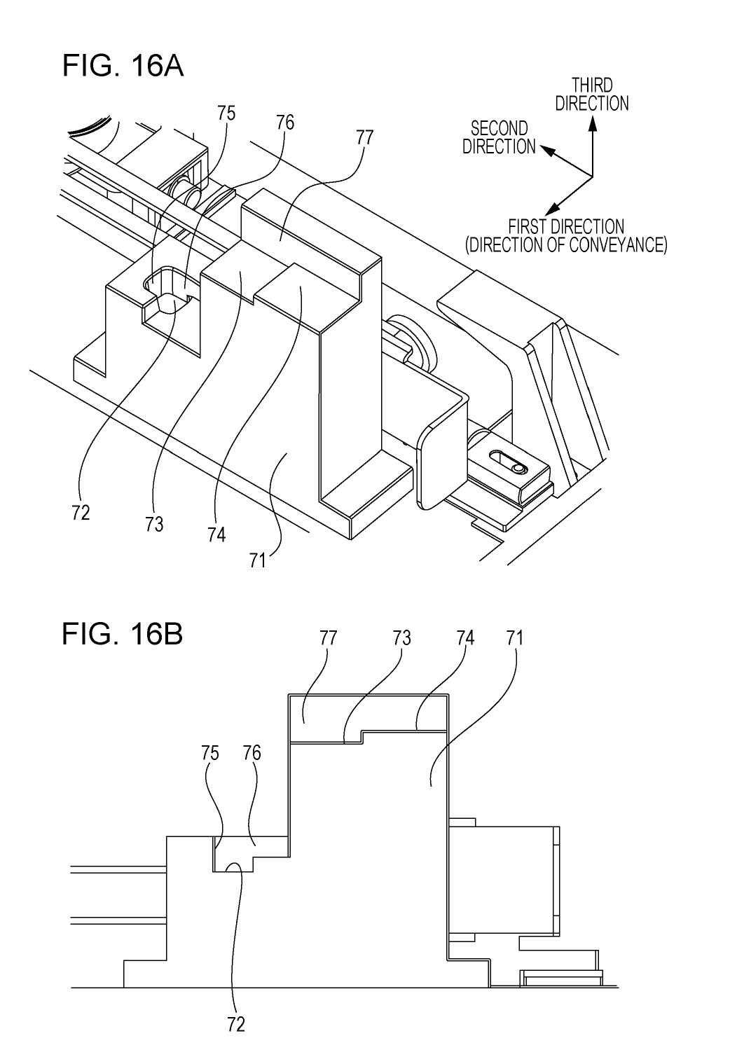

FIGS. 16A and 16B are enlarged views of the reference member 71 in the cleaning portion 6 and its adjacent areas. FIG. 16A is a perspective view, and FIG. 16B is a side view. FIGS. 17A to 17C illustrate states where the reference member 71 is actually in contact. The reference member 71 includes three reference surfaces having different heights in the third direction: a first contact surface 73, a second contact surface 74, and a third contact surface 72. The reference member 71 further includes fourth contact surface 76 and fifth contact surface 77 coming into contact with the positioning member 81 (see FIGS. 17A to 17C) in the first direction and a sixth contact surface 75 coming into contact therewith in the second direction. That is, the reference member 71 is used for positioning the head holder 5 in first, second, and third directions and provides three reference surfaces for the third direction.

FIG. 17A illustrates a positional relationship between the reference member 71 and the positioning member 81 fixed to the head holder 5 in capping mode (capping-mode position). FIG. 17B illustrates a positional relationship between the reference member 71 and the positioning member 81 in suction mode (suction-mode position). FIG. 17C illustrates a positional relationship between the reference member 71 and the positioning member 81 in wiping mode (wiping-mode position). In all of the modes, the reference member 71 and its paired positioning member 81 have the same positional relationship at each of four locations.

In capping mode, the recording head 2 is in intimate contact with the cap 51, and capping the nozzle surface can reduce drying of the nozzles. As illustrated in FIG. 17A, the positioning member 81 is in contact with the reference member 71 at the fourth contact surface 76 in the first direction, at the sixth contact surface 75 in the second direction, and at the third contact surface 72 in the third direction, and is in the capping-mode position.

In suction mode, while the tip of the suction port 11 is in contact with the nozzle surface of the recording head 2 and the negative-pressure producing unit produces a negative pressure in the suction port 11, the wiper unit 46 is moved along the second direction in a scanning manner to suck ink and dirt from the suction port 11 and remove them. As illustrated in FIG. 17B, the positioning member 81 is in contact with the reference member 71 at the fifth contact surface 77 in the first direction and at the first contact surface 73 in the third direction, and is in the suction-mode position. They are not in contact in the second direction.

In wiping mode, when the tips of the blades 21 and the nozzle surface of the recording head 2 are in contact with an appropriate pressure, the wiper unit 46 is moved along the second direction in a scanning manner to wipe ink and dirt off the nozzle surface using the blades 21. As illustrated in FIG. 17C, the positioning member 81 is in contact with the reference member 71 at the fifth contact surface 77 in the first direction and at the second contact surface 74 in the third direction, and is in the wiping-mode position. They are not in contact in the second direction. In this way, even with a simple structure, the recording head 2 can be accurately positioned in each operation mode, and each operation mode can be reliably implemented.

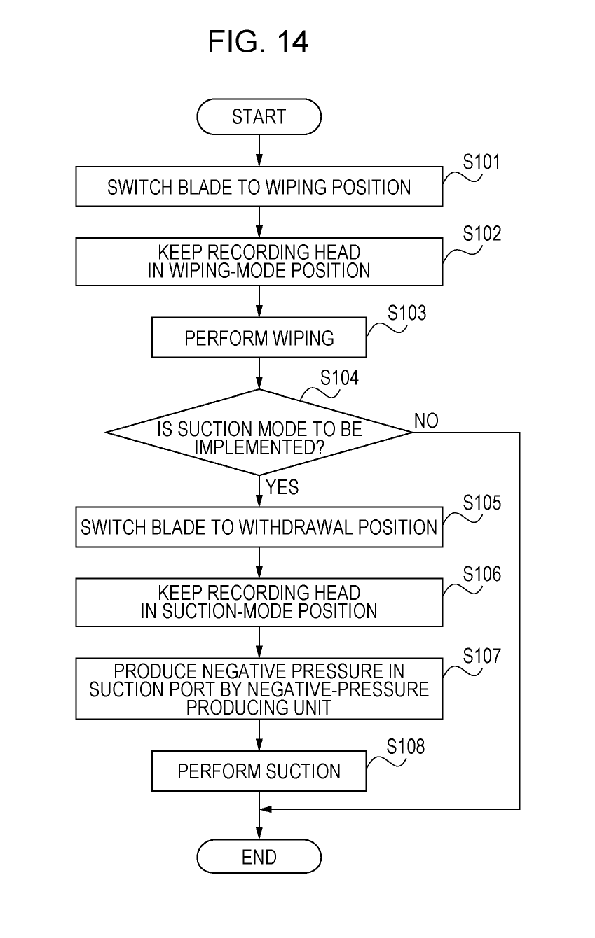

FIG. 14 is a flowchart of a cleaning operation sequence. When it is determined that there is no nozzle in which ejection is poor, wiping mode is selected. In step S101, the blade 21 is switched to the wiping-mode position (see FIG. 12B). In step S102, the recording head 2 is kept in the wiping-mode position. This is enabled by the positional relationship between the reference member 71 and the positioning member 81 set in the wiping-mode position (see FIG. 17C). In step S103, wiping is performed by the wiper unit 46 being moved along the second direction in a scanning manner. The blade 21 wipes ink and dirt from the nozzle surface and the base substrate 124 to remove them. In this way, without consuming ink from nozzles, cleaning by wiping the nozzle surface can be achieved.

Then in step S104, in response to determination whether there is a nozzle in which ejection is poor, it is determined whether suction mode is to be implemented (YES) or not (NO). If the determination in step S104 is YES, flow proceeds to step S105; if it is NO, the sequence ends. In step S105, the blade 21 is switched to the withdrawal position to implement suction mode (see FIG. 12A). In step S106, the recording head is kept in the suction-mode position. This is enabled by the positional relationship between the reference member 71 and the positioning member 81 set in the suction-mode position (see FIG. 17B). In step S107, a negative pressure is produced in the suction port 11 by the negative-pressure producing unit. In step S108, while the wiper unit 46 is moved along the second direction in a scanning manner, suction is performed using the suction port 11 to suck ink and dirt from the nozzle surface and nozzles. In this way, cleaning by suction can be achieved with a reduced consumption of ink from nozzles.

After continuous recording on a sheet in large quantities, a large amount of ink and dirt may be attached to the nozzle surface and the base substrate 124. In such a case, cleaning in suction mode is performed subsequently to cleaning in wiping mode. Ink and dirt are wiped and removed from the nozzle surface and the base substrate 124 in wiping mode, and then, ink and dirt on the nozzle surface and nozzles are sucked in suction mode. In this way, the total time required for a cleaning operation can be shortened, and cleaning can be achieved with a reduced consumption of ink from nozzles.

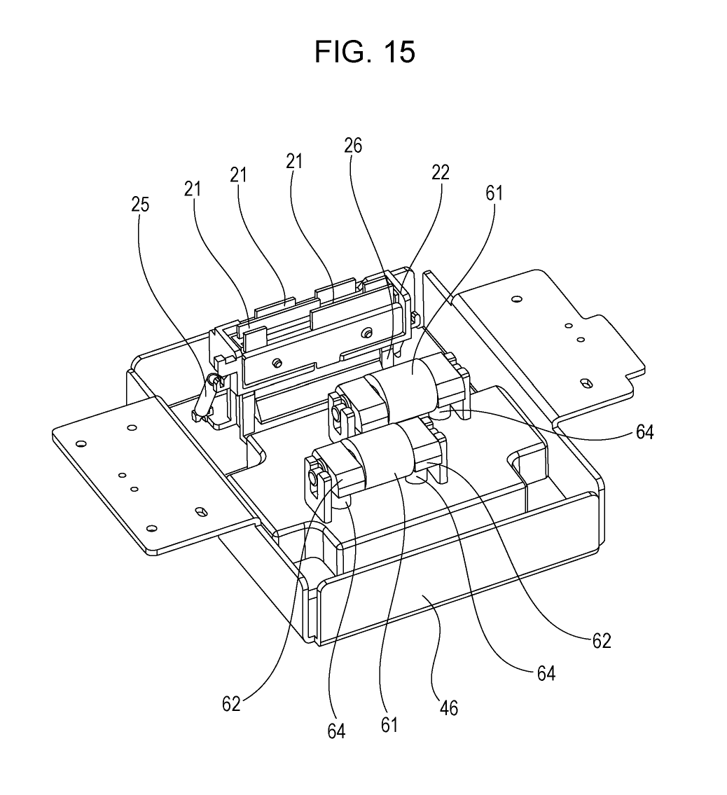

In the above embodiment, the suction portion performs suction using a negative pressure, but it is not limited to this manner. For example, the suction portion may use an ink absorber 61 in suction, instead of a negative pressure, as illustrated in FIG. 15. The ink absorber 61 includes a first ink absorber and a second ink absorber and is supported by an absorber holder 62. The absorber holder 62 is urged by a spring 64 being an elastic body in a direction substantially perpendicular to the nozzle surface of the recording head 2 (third direction) and is movable in the third direction against the spring. The contact portions of the first and second ink absorbers are positioned at the same locations as the first suction port 11a and the second suction port 11b illustrated in FIG. 6, which is previously described. If the ink absorber 61 is made of a material having high absorbency, for example, porous material, a large amount of ink can be sucked per unit time. Because the distances Lh and Lc are equal, the contact portion of the first ink absorber and that of the second ink absorber confront the corresponding sealing portions 123 of the corresponding nozzle chips 120 at substantially the same time. After that, the first ink absorber and the second ink absorber also confront the nozzle arrays included in the first and second nozzle chips 120, respectively, at substantially the same time. Therefore, in suction mode, reliability in cleaning of nozzles is improved.

In the above embodiment, an example in which the nozzle chips 120 are arranged in a staggered configuration having two rows is illustrated. However, other regular arrangements can be used. Whatever the case may be, the recording head 2 includes a plurality of first nozzle chips each having nozzle arrays and a plurality of second nozzle chips each having nozzle arrays arranged in different rows in a second direction and is in a positional relationship in which the first nozzle chips and the second nozzle chips adjacent to each other are displaced from each other in the second direction. Additionally, nozzle arrays included in the neighboring first and second nozzle chips partly overlap each other in the second direction.

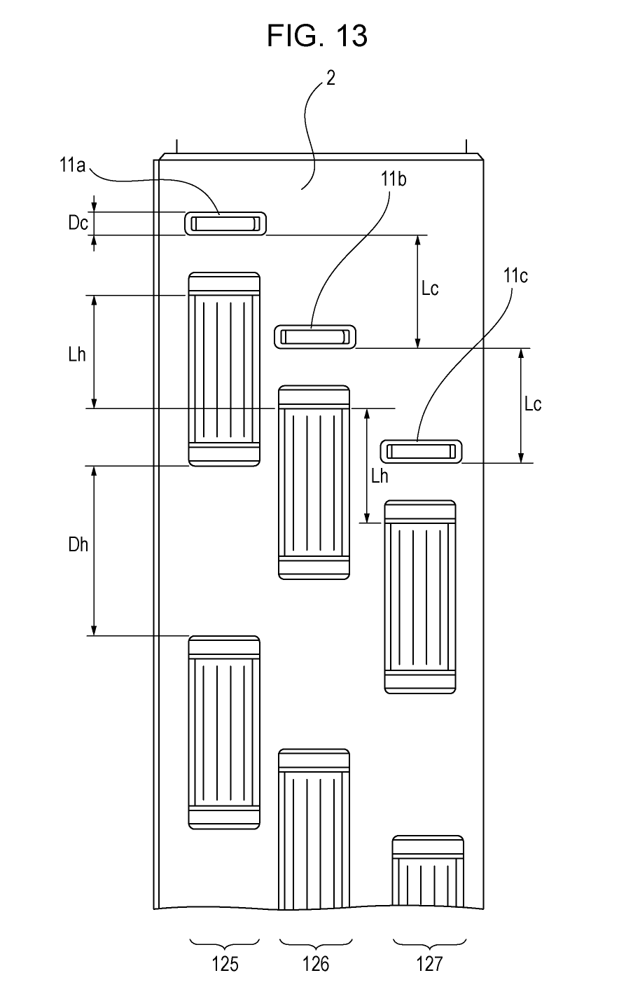

FIG. 13 illustrates another example arrangement of nozzle chips. The nozzle chips are regularly arranged in three rows of the first nozzle-chip row 125, second nozzle-chip row 126, and third nozzle-chip row 127. The three suction ports of the first suction port 11a, second suction port 11b, and third suction port 11c are arranged so as to face the corresponding nozzle chips in the three rows. In the second direction, all of the distance (amount of displacement) between the first suction port 11a and the second suction port 11b, that between the second suction port 11b and the third suction port 11c, and that between the third suction port 11c and the first suction port 11a is Lc. In the second direction, all of the distance (amount of displacement) between neighboring nozzle chips in the first and second rows, that between neighboring nozzle chips in the second and third rows, and neighboring nozzle chips in the third and first rows is Lh. As in the case of the example illustrated in FIG. 6, Lc and Lh are equal (as previously described, they may be virtually equal). Also, the width Dc and the distance Dh satisfy the relationship Dc<Dh. Accordingly, during suction performed on nozzles using the first suction port 11a, the second suction port 11b, and the third suction port 11c, unstable suction resulting from undesired tilting or pushing of the suction holder 12 does not occur, so reliability in cleaning of nozzles is improved. In this manner, for two of the plurality of rows, the first suction portion and the second suction portion are in a positional relationship in which they are displaced in the second direction so as to correspond to displacement between neighboring first and second nozzle chips in different rows.

In the above embodiment, the wiper unit 46 is moved with respect to the fixed recording head 2. However, embodiments of the present invention are not limited to the above-described example. For example, a system in which cleaning is performed by moving a recording head with respect to a wiper unit can be used. That is, embodiments of the present invention are also applicable to a recording apparatus that includes an ink suction portion relatively movable along a direction in which nozzle arrays are arranged so as to face part of nozzles in a nozzle array of a recording head.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-113434 filed May 17, 2010, which is hereby incorporated by reference herein in its entirety.

What is claimed is:

1. An apparatus comprising:
a recording head disposed at a location that faces a sheet moving in a first direction, the recording head including a plurality of first nozzle chips and a plurality of second nozzle chips arranged in different rows along a second direction that intersects the first direction, each of the plurality of first nozzle chips and each of the plurality of second nozzle chips including a nozzle array, and in which the first nozzle chips and the second nozzle chips adjacent to each other are displaced from each other in the second direction;
a first suction portion configured to face the first nozzle chip and suck ink from part of the nozzle array included in the first nozzle chip;
a second suction portion configured to face the second nozzle chip and suck ink from part of the nozzle array included in the second nozzle chip;
a suction holder configured to hold the first suction portion and the second suction portion;
a movement mechanism configured to cause relative movement between the recording head and the suction holder along the second direction while suction is performed; and
a positioning member for use in positioning the recording head at a plurality of locations in a third direction that intersects the first and second directions,
wherein the first suction portion and the second suction portion are in a positional relationship in which they are displaced in the second direction so as to correspond to displacement between the first nozzle chip and the second nozzle chip.

2. The apparatus according to claim 1, wherein, in the second direction, a distance of displacement between the neighboring first and second nozzle chips and a distance of displacement between the first and second suction portions are equal.

3. The apparatus according to claim 1, wherein the first suction portion includes a first suction port capable of becoming adjacent to the first nozzle chip, the second suction portion includes a second suction port capable of becoming adjacent to the second nozzle chip, and a negative pressure for sucking ink from the nozzle array is provided to each of the first suction port and the second suction port.

4. The apparatus according to claim 3, wherein the suction holder is supported by a displacement mechanism including an elastic body so as to be able to be displaced rectilinearly in a direction of a gap between a nozzle surface of the recording head and the sheet.

5. The apparatus according to claim 3, wherein a relationship Dc<Dh is satisfied, where Dc is a width of the first suction port or the second suction port in the second direction and Dh is a gap of the neighboring nozzle chips in the same row in the second direction.

6. The apparatus according to claim 1, wherein each of the first suction portion and the second suction portion has different suction forces for forward movement and backward movement caused by the movement mechanism.

7. The apparatus according to claim 1, wherein moving speeds for forward movement and backward movement caused by the movement mechanism are different.

8. The apparatus according to claim 1, wherein the first suction portion includes a first ink absorber configured to come into contact with the first nozzle chip and absorb ink from the part of the nozzle array, and the second suction portion includes a second ink absorber configured to come into contact with the second nozzle chip and absorb ink from the part of the nozzle array.

9. The apparatus according to claim 1, further comprising:
a first blade configured to wipe a nozzle surface of the first nozzle chip; and
a second blade configured to wipe a nozzle surface of the second nozzle chip,
wherein wiping is performed while the first blade and the second blade are relatively moved with respect to the recording head by the movement mechanism along the second direction.

10. The apparatus according to claim 9, further comprising:
a blade holder configured to hold the first blade and the second blade; and
a switching unit configured to switch the blade holder between a wiping position and a withdrawal position.

11. The apparatus according to claim 10, wherein the blade holder and the suction holder are disposed on a common support, and a site of each of the first suction portion and the second suction portion that is nearest the nozzle surface is present between a location of a tip of the first blade or the second blade in the wiping position and a location of the tip in the withdrawal position.

12. The apparatus according to claim 1, wherein the positioning member is capable of positioning the recording head in different positions in suction mode, wiping mode, and capping mode.

13. The apparatus according to claim 1, further comprising:
a first blade configured to wipe a nozzle surface of the first nozzle chip;
a second blade configured to wipe a nozzle surface of the second nozzle chip;
a blade holder configured to hold the first blade and the second blade;
a common support configured to hold the suction holder and the blade holder;
a reference member fixed to the support; and
a head holder configured to hold the recording head,
wherein the positioning member is fixed to the head holder and capable of coming into contact with the reference member,
the movement mechanism is configured to cause relative movement between the recording head and the support along the second direction,
the reference member includes a first contact surface and a second contact surface at different locations in the third direction,
in suction mode, the positioning member comes into contact with the first contact surface to position the recording head, and
in wiping mode, the positioning member comes into contact with the second contact surface to position the recording head.

14. The apparatus according to claim 13, further comprising a cap capable of capping the recording head,
wherein the reference member further includes a third contact surface at a different location in the third direction from each of the first contact surface and the second contact surface, and
in capping mode, the positioning member comes into contact with the third contact surface to position the recording head.

15. The apparatus according to claim 1, wherein each of the first nozzle chip and the second nozzle chip includes a sealing portion in the vicinity of its end in the second direction, and at least part of the sealing portion is higher than the nozzle surface in a direction in which ink is ejected.

16. An apparatus comprising:
a recording head disposed to face a sheet moving in a first direction, the recording head including a plurality of first nozzle chips and a plurality of second nozzle chips arranged in different rows along a second direction that intersects the first direction, each of the plurality of first nozzle chips and each of the plurality of second nozzle chips including a nozzle array, and in which the first nozzle chips and the second nozzle chips adjacent to each other are displaced from each other in the second direction;
a first suction portion configured to face the first nozzle chip and suck ink from part of the nozzle array included in the first nozzle chip;
a second suction portion configured to face the second nozzle chip and suck ink from part of the nozzle array included in the second nozzle chip;
a suction holder configured to hold the first suction portion and the second suction portion;
a first blade configured to wipe a nozzle surface of the first nozzle chip;
a second blade configured to wipe a nozzle surface of the second nozzle chip;
a blade holder configured to hold the first blade and the second blade;
a common support configured to hold the suction holder and the blade holder, wherein a reference member is fixed to the support;
a movement mechanism configured to cause relative movement between the recording head and the support along the second direction; and
a head holder configured to hold the recording head, wherein a positioning member capable of coming into contact with the reference member is fixed to the head holder,
wherein the reference member includes a first contact surface and a second contact surface at different locations in a third direction that intersects the first direction and the second direction,
in suction mode of performing suction using the first suction portion and the second suction portion, the positioning member comes into contact with the first contact surface to position the recording head, and
in wiping mode of performing wiping using the first blade and the second blade, the positioning member comes into contact with the second contact surface to position the recording head.

17. The apparatus according to claim 16, further comprising a cap capable of capping the recording head,
wherein the reference member further includes a third contact surface at a different location in the third direction from each of the first contact surface and the second contact surface, and
in capping mode, the positioning member comes into contact with the third contact surface to position the recording head.

18. The apparatus according to claim 16, wherein the reference member includes a contact surface configured to come into contact with the positioning member in the first direction, and
in wiping mode, the recording head is positioned in each of the third direction and the first direction.

19. The apparatus according to claim 16, wherein each of the first nozzle chip and the second nozzle chip includes a sealing portion in the vicinity of its end in the second direction, and at least part of the sealing portion is higher than the nozzle surface in a direction in which ink is ejected.
